(19) United States
(12) Patent Application Publication
(10) Pub. No.: US 2016/0031024 A1
(43) Pub. Date: Feb. 4, 2016

(54) Thread Cutter Drive Extension

(71) Applicant: Hong Ann Tool Industries Co., Ltd., Taichung City (TW)

(72) Inventor: Cheng-Wei Su, Taichung City (TW)

(21) Appl. No.: 14/724,870

(22) Filed: May 29, 2015

(30) Foreign Application Priority Data
Jul. 31, 2014 (TW) 103126137

(51) Int. Cl. B23G 5/10

(52) U.S. Cl. CPC B23G 5/10

(57) ABSTRACT

A thread cutter drive extension includes a main body defining first and second connecting ends. The main body includes a cavity circumferentially delimited in the second connecting end and a hole extending radially through the connecting end and into the cavity. A tightening device is disposed on the main body. The tightening device includes a tightener adjustably engaged in the hole. The tightener is movable between a tight position engaging in the cavity and a release position disengaging from the cavity. The thread cutter drive extension defines a driven end at the first connecting end. The thread cutter drive extension is adapted to be driven by a power tool, with the power tool connecting to the first connecting end. The thread cutter drive extension is adapted to receive a thread die, with the thread die disposed in the cavity.

### BACKGROUND OF THE INVENTION

1. Field of the Invention

The present invention relates to an extension tool and, particularly, to an extension tool adapted to create threads on a work piece and adapted to be driven by a power tool.

2. Description of the Related Art

TW Pat. No. 323563 shows a thread-cutting device. The thread-cutting device includes a thread cutter and two handles. The thread cutter is disposed between the two handles. The two handles extend oppositely. In using the thread-cutting device to create threads on a work piece, the two handles are used as leverage to turn the thread cutter. A user can facilitate the effort to turn the thread cutter by two hands, with one of the hands grasping one of the two handles and the other hand grasping the other handle, respectively. Even so, turning the handles repeatedly can be tiresome and inefficient.

The present invention is, therefore, intended to obviate or at least alleviate the problems encountered in the prior art.

### SUMMARY OF THE INVENTION

According to the present invention, a thread cutter drive extension includes a main body extending in a lengthwise direction from a first end thereof to a second end thereof. The main body defines a first connecting end at the first end thereof and a second connecting end at the second end thereof, respectively. The main body includes a cavity circumferentially delimited in the second connecting end and a hole extending radially through the connecting end and into the cavity. A tightening device is disposed on the main body. The tightening device includes a tightener adjustably engaged in the hole. The tightener is movable between a tight position engaging in the cavity and a release position disengaging from the cavity.

The thread cutter drive extension defines a driven end at the first connecting end. The thread cutter drive extension is adapted to be driven by a power tool, with the power tool connecting to the first connecting end.

The thread cutter drive extension is adapted to receive a thread die, with the thread die disposed in the cavity.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is an object of the present invention to provide a thread cutter drive extension which can create threads on a work piece.

It is another object of the present invention to provide a thread cutter drive extension which is adapted to be driven by a power tool, and which allows a user to operate the thread-cutting device in an effort-saving and efficient manner.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of a thread cutter drive extension in accordance with a first embodiment of the present invention with a thread cutter.

FIG. 2 is an exploded perspective view of the thread cutter drive extension and the thread cutter shown in FIG. 1.

FIG. 3 is a cross-sectional view of the thread cutter drive extension and the thread cutter shown in FIG. 1.

FIG. 4 is a cross-sectional view illustrating the thread cutter on the thread cutter drive extension substituted by a replacement.

FIG. 5 is a perspective view illustrating the thread cutter drive extension being connectable to a power tool.

FIG. 6 is an exploded perspective view of a thread cutter drive extension in accordance with a second embodiment of the present invention with a thread cutter.

FIG. 7 is a cross-sectional view of the thread cutter drive extension and the thread cutter shown in FIG. 6.

FIG. 8 is a cross-sectional view illustrating the thread cutter on the thread cutter drive extension substituted by a replacement.

### DETAILED DESCRIPTION OF THE INVENTION

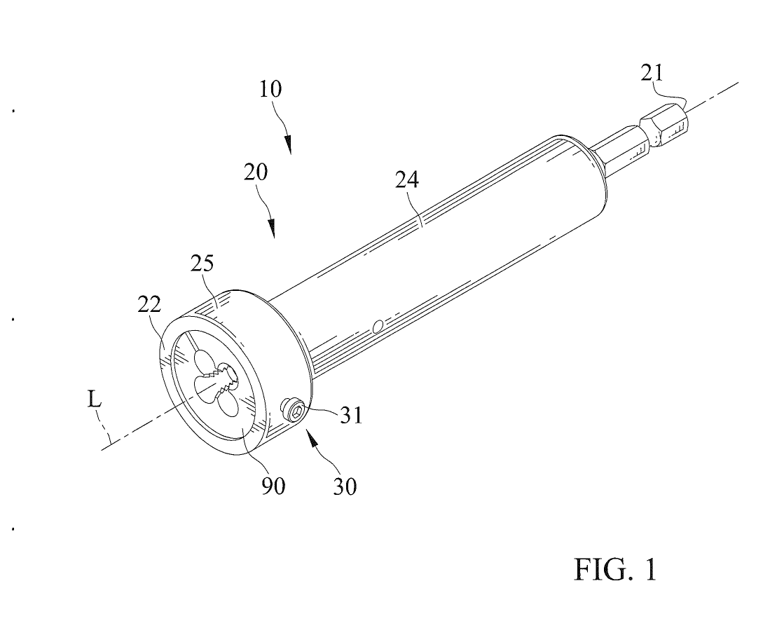

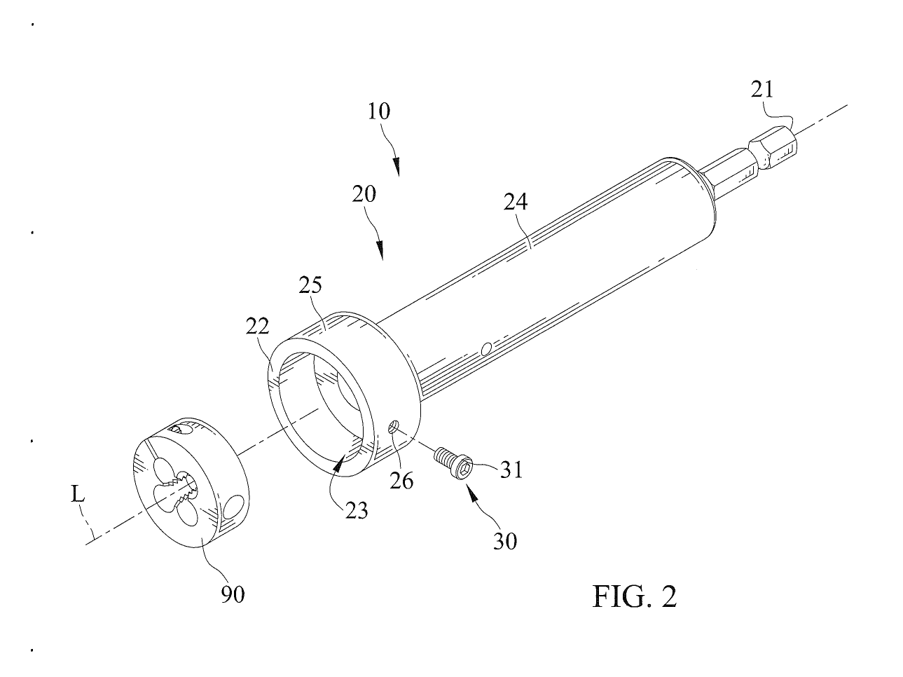

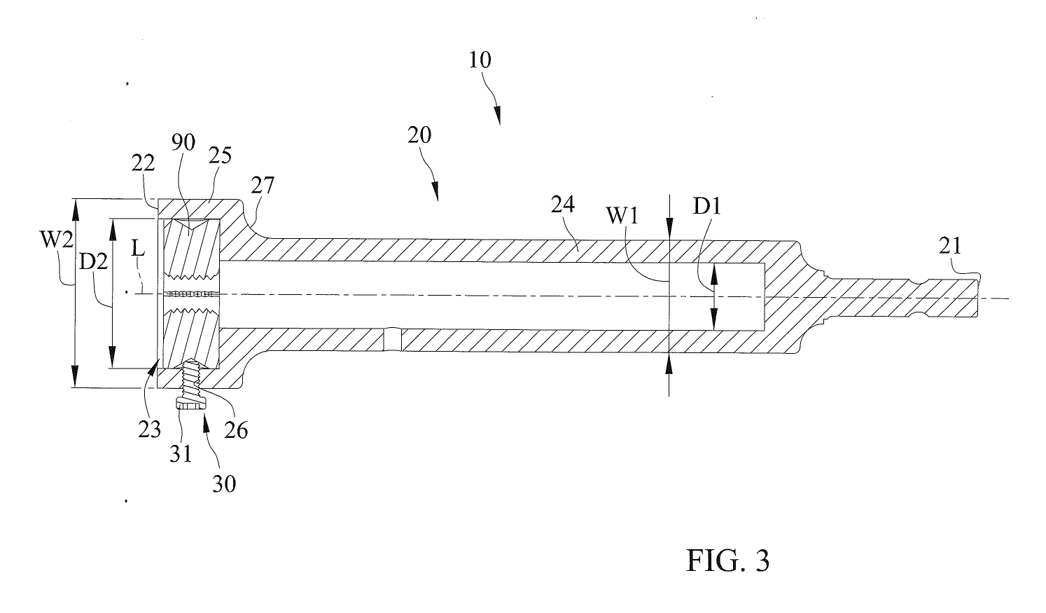

FIGS. 1 through 5 show a thread cutter drive extension 10 in accordance with a first embodiment of the present invention. The thread cutter drive extension 10 includes a main body 20 and a tightening device 30.

The main body 20 extends in a lengthwise direction from a first end thereof to a second end thereof. The main body 20 extends along a phantom axis L from the first end thereof to the second end thereof. The phantom axis L extends at a center of the main body 20. The main body 20 defines a first-connecting end 21 at the first end thereof and a second connecting end 22 at the second end thereof, respectively. The first connecting end 21 is in a form of a polygonal structure with a neck having a curved edge. The main body 20 includes a cavity 23 circumferentially delimited in the second connecting end 22 and a hole 26 extending radially through the second connecting end 22 and into the cavity 23. The cavity 23 recesses from the second end of the main body 20. The cavity 23 extends in the lengthwise direction of the main body 20 from a first end thereof to a second end thereof. The cavity 23 has a first opening at the first end thereof and a second opening at the second end thereof, respectively. The second opening has a smaller diameter than the first opening. The main body 20 includes a channel 28. The channel 28 extends in the lengthwise direction of the main body 20 from a first end thereof to a second end thereof. The channel 28 has an open end at the first end thereof and a closed end at the second end thereof, respectively. The second opening of the cavity 23 coincides with the open end of the channel 28. The cavity 23 has a first diameter D1 defining a maximum diameter of the cavity and the channel 28 has a second diameter D2 defining a maximum diameter of the channel 28, respectively. The first diameter D1 is smaller than the second diameter D2. The main body 20 includes a first length section 24 and a second length section 25. The channel 28 extends in the first length section 24 of the main body 20. The cavity 23 extends in the second length section 25 of the main body 20. The channel 28 has a longer length than the cavity 23. The first length section 24 of the main body 20 has a longer length than the second length section 25 of the main body 20. The main body 20 has first and second widths W1 and W2 in a widthwise direction thereof. The first width defines a minimum width of an outer periphery at the first length section 24 and the second width W2 defines a minimum width of an outer periphery at the section length section 25, respectively. The second width W2 is greater than the first width W1. The main body 20 forms a shoulder 27 extending radially from the outer periphery of the first length section thereof to the outer periphery of the second length section thereof.

The tightening device 30 is disposed on the main body 20. The tightening device 30 includes a tightener 31 adjustably engaged in the hole 26. The tightener 31 is movable between a tight position engaging in the cavity 23 and a release position disengaging from the cavity 23. The tightener 31 and the hole 26 are threadly engaged with each other. The tightener 31 includes first plurality of threads and the hole 26 includes second plurality of threads engaging with the first plurality of threads. Because the tightener 31 and the hole 26 are threadly engaged with each other, the tightener 31 is movable to a fixed position in the hole 26.

The thread cutter drive extension 10 defines a driven end at the first connecting end 21. The thread cutter drive extension 10 is adapted to be driven by a power tool 91. The power tool 91 connects to the first connecting end 21. The power tool 91 includes electric tools and pneumatic tools. Since the first connecting end 21 is in the form of a polygonal structure. The thread cutter drive extension 10 and the power tool 91 can be connected to rotate together.

The thread cutter drive extension 10 is adapted to receive a thread die 90. The thread die 90 is disposed in the cavity 23. The second distal end of the cavity 23 bears the thread die 90 disposed therein. The thread die 90 and the cavity 23 have matching shapes. The thread die 90 is able to be insertably disposed in the cavity 23. The thread die 90 is adapted to be releasably retained the cavity 23 by the tightener 31. The thread die 90 is able to be fixedly retained in the cavity 23. The thread die 90 includes at least one recess. The at least one recess extends into an outer periphery of the thread die 90. The at least one recess has two opposite ends, with one end being an open end on the outer periphery of the thread die 90 and the other end being a closed end. The thread die 90 fixedly retained in the cavity 23 includes the tightener 31 moved to the tight position thereof and abutting the closed end of the at least one recess.

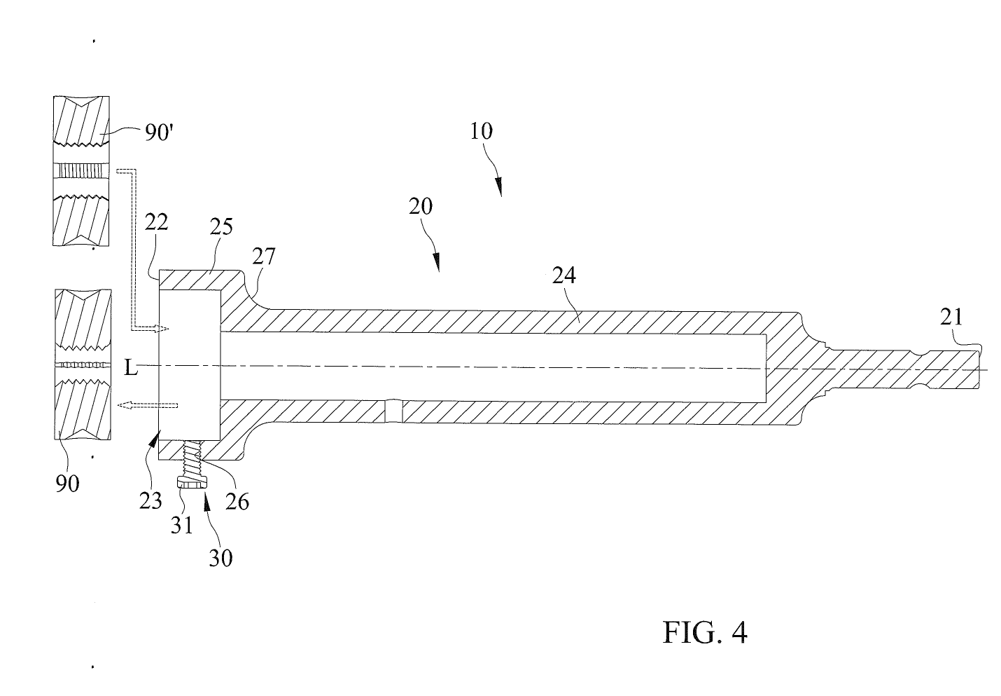

As shown in FIG. 4, the thread die 90 is substituted by a replacement, a thread die 90′. The thread die 90′ has a center hole with a size different from that of the center hole of the thread die 90. Therefore, work pieces to be manufactured by the respective thread dies 90 and 90′ have different diametrical sizes.

The thread die 90 includes a center hole and a plurality of holes. The center hole and the plurality of holes extend through the thread die 90 in the same direction. The center hole is at the center of the thread die 90, and the plurality of the holes is disposed around the center hole. The center hole and each of the plurality of holes are connected such that the center hole and each of the plurality of holes have an opening on either a circumference of the center hole or a circumference of each of the plurality of holes. Threads are formed on the circumference of the center hole. The phantom axis L extends at a center of the center hole of the thread die 90. The thread die 90 is a round thread die.

The thread die 90 can create threads on a work piece. By fixing the thread die 90 to the thread cutter drive extension 10 which is adapted to be driven by the power tool 91, the thread die 90 is able to be driven by the power tool 91.

The process of using the thread die 90 to create threads on the work piece includes inserting the work piece into the center hole of the thread die 90, and rotating the thread die 90 relative to the work piece to enable the threads on the circumference of the center hole to cut threads on the work piece.

The more the thread die 90 is rotated to create more threads on the work piece, the further the work piece moves through the thread die 90 and into the channel 28. Therefore, the length of the channel 28 can affect thread numbers on the work piece.

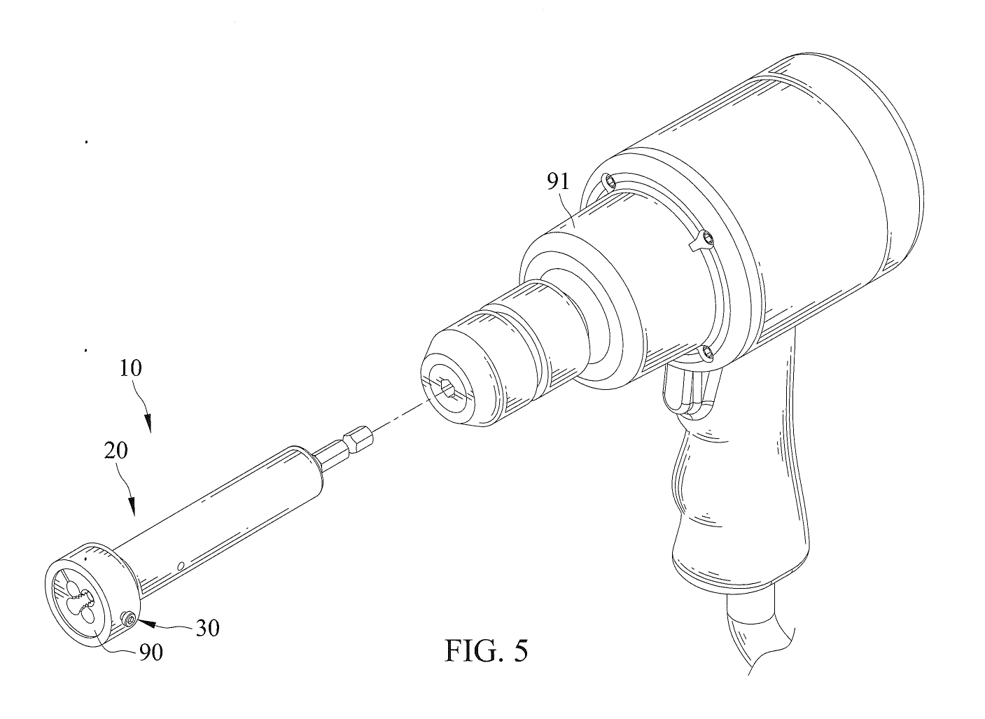

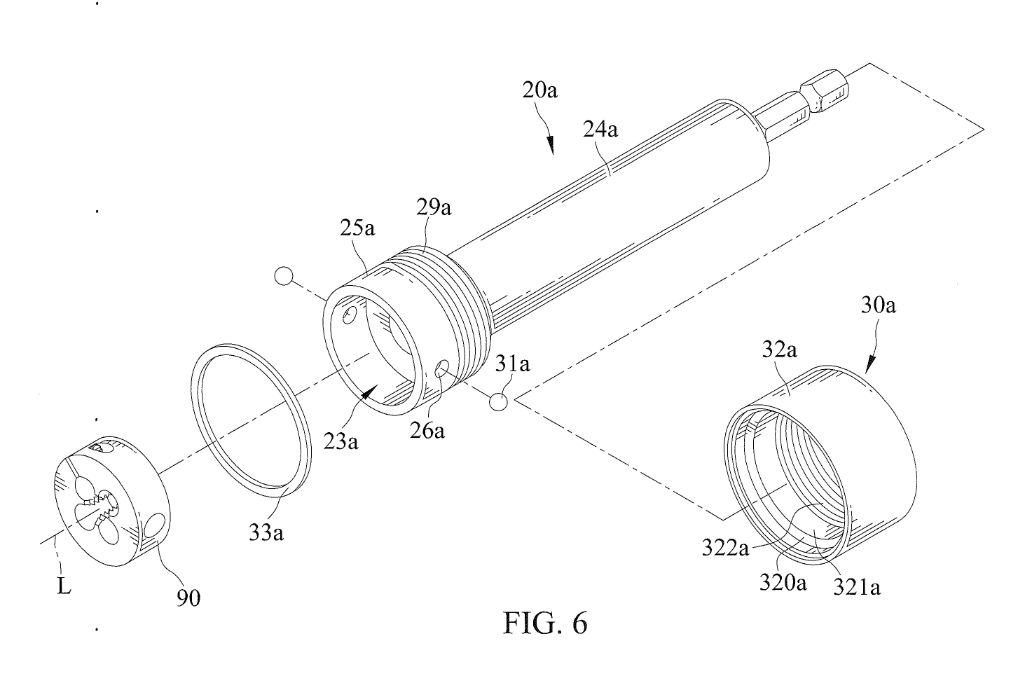

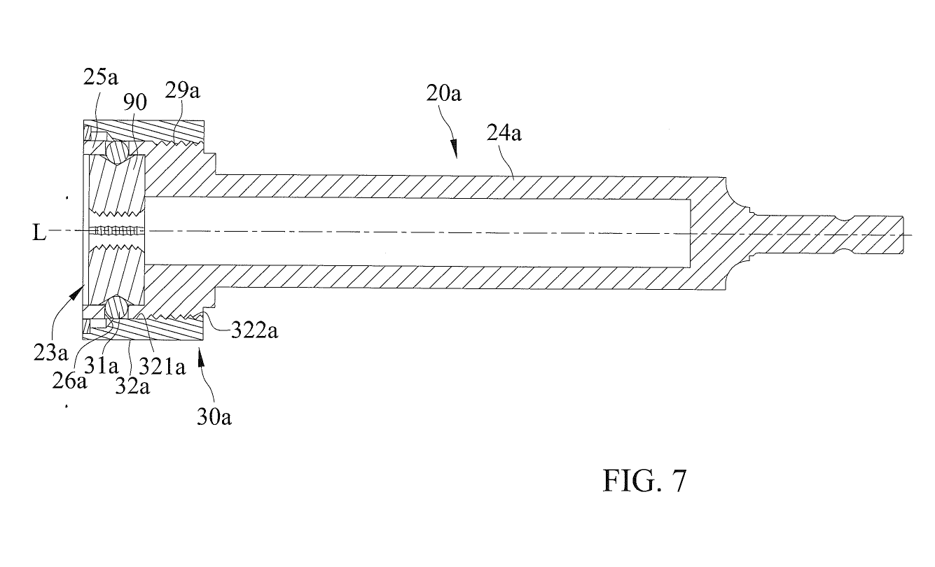

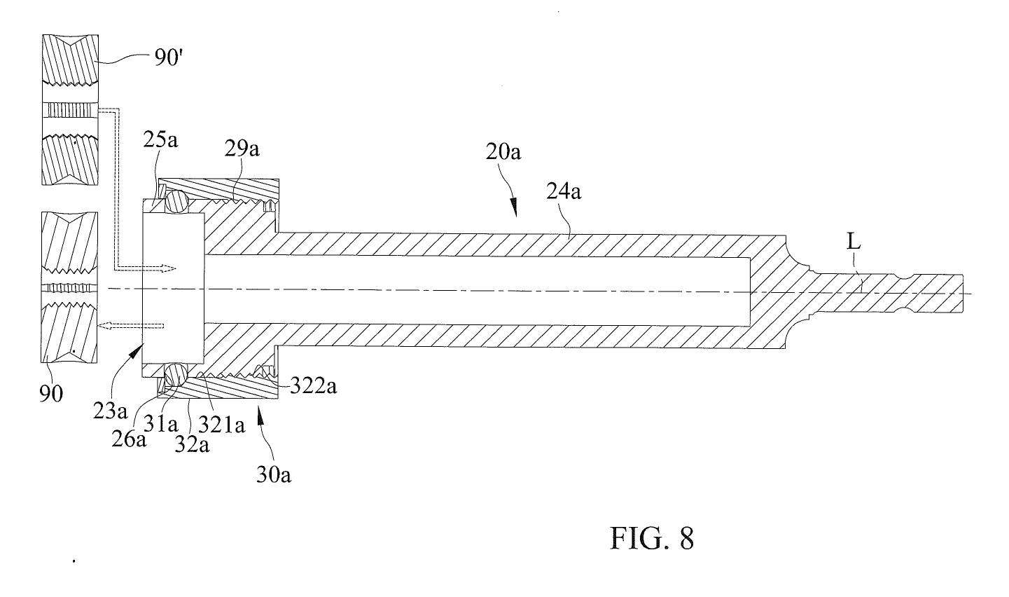

FIGS. 5 through 8 show a thread cutter drive extension in accordance with a first embodiment of the present invention, and same numbers are used to correlate similar components of the first embodiment, but bearing a letter a. The second embodiment is the same as the first embodiment except that a main body 20a replaces the main body 20 and a tightening device 30a replaces the tightening device 30. The second embodiment has the same arrangements and geometries as the first embodiment. Therefore, similarity is not described repeatedly.

The main body 20a includes a first length section 24a and a second length section 25a. A cavity 23a extends in the second length section of the main body 20a. Outer thread 29a extends on the second length section 25a of the main body 20a. A hole 26a is not a thread hole and has a smooth circumferential edge.

The tightening device 30a includes a tightener 31a. The tightener 31a is in a form of a sphere. The tightening device 30a further includes a sleeve 32a adjustably engaged with the main body 20a and includes an inner periphery thereof defining a first circumferential region 320a and a second circumferential region 321a selectively abutting the tightener 31a. The sleeve 32a is hollow and includes the inner periphery thereof delimiting a through hole. The main body 20a is inserted through the through hole of the sleeve 32a. The first and second circumferential regions 320a and 321a are at different diametrical distances from a center of the sleeve 32a. The first circumferential region 320a is at a greater diametrical distance from the center of the sleeve 32a than the second circumferential region 321a. The sleeve 32a is adjustable to a first position including the first circumferential region 320a thereof receiving the tightener 31a such that the tightener 31a is moved to the release position thereof, and to a second position including the second circumferential region 321a thereof receiving the tightener 31a such that the tightener 31a is moved to the tight position thereof. The main body 20a and the sleeve 32a are threadly engaged with each other. The sleeve 32a includes inner threads 322a engaging with the outer threads 29a. Because the main body 20a and the sleeve 32a are threadly engaged with each other, the sleeve 32a is movable to a fixed position on the main body 20a. The inner threads 322a extend on the inner periphery of the sleeve 32a. The second circumferential region 321a is located between the first circumferential region 320a and the inner threads 322a.

The sleeve 32a includes the inner periphery thereof defining a grooved circumferential region. The sleeve 32a includes a retainer ring 33a disposed in the grooved circumferential region. The retainer ring 33a is movable with the sleeve 32a. The main body 20a is inserted through a hole of the retainer ring 33a. The first circumferential region 320a is located between retainer ring and the second circumferential region 321a. The tightener 31a is retained between the retainer ring 33a and the second circumferential region 321a when the tightener 31a is moved to the release position thereof. The retainer ring 33a is elastic.

In view of the foregoing, each of the thread cutter drive extensions 10 is adapted to be driven by the power tool 91. The power tool 91 allows a user to operate the thread-cutting device in an effort-saving and efficient manner. The thread dies 90 and 90′ are replaceable on the thread cutter drive extensions 10. The thread cutter drive extension 10 defines the driven end at the first connecting end 21. The power tool 91 connects to the first connecting end 21. The thread dies 90 and 90′ are received in the cavities 23, 23a of the respective thread cutter drive extensions 10.

While the specific embodiments have been illustrated and described, numerous modifications come to mind without significantly departing from the spirit of invention, and the scope of invention is only limited by the scope of accompanying claims.

What is claimed is:

1. A thread cutter drive extension comprising:
a main body extending in a lengthwise direction from a first end thereof to a second end thereof, defining a first connecting end at the first end thereof and a second connecting end at the second end thereof respectively, and including a cavity circumferentially delimited in the second connecting end and a hole extending radially through the second connecting end and into the cavity; and
a tightening device disposed on the main body and including a tightener adjustably engaged in the hole, with the tightener movable between a tight position engaging in the cavity and a release position disengaging from the cavity;
wherein the thread cutter drive extension defines a driven end at the first connecting end, with the thread cutter drive extension adapted to be driven by a power tool, and with the power tool connecting to the first connecting end; and
wherein the thread cutter drive extension is adapted to receive a thread die, with the thread die disposed in the cavity.

2. The thread cutter drive extension as claimed in claim 1, wherein the thread die is adapted to be releasably retained the cavity by the tightener.

3. The thread cutter drive extension as claimed in claim 1, wherein the cavity extends in the lengthwise direction of the main body from a first end thereof to a second end thereof, wherein the cavity has a first opening at the first end thereof and a second opening at the second end thereof respectively, and wherein the second opening has a smaller diameter than the first opening.

4. The thread cutter drive extension as claimed in claim 3, wherein the main body includes a channel, wherein the channel extends in the lengthwise direction of the main body from a first end thereof to a second end thereof, wherein the channel has an open end at the first end thereof and a closed end at the second end thereof respectively, and wherein the second opening of the cavity coincides with the open end of the channel.

5. The thread cutter drive extension as claimed in claim 4, wherein the cavity has a first diameter defining a maximum diameter of the cavity and the channel has a second diameter defining a maximum diameter of the channel respectively, and wherein the first diameter is smaller than the second diameter.

6. The thread cutter drive extension as claimed in claim 1, wherein the tightener and the hole are threadly engaged with each other, with the tightener including first plurality of threads and the hole includes second plurality of threads engaging with the first plurality of threads.

7. The thread cutter drive extension as claimed in claim 1, wherein the tightening device further includes a sleeve adjustably engaged with the main body and includes an inner periphery thereof defining a first circumferential region and a second circumferential region selectively abutting the tightener, wherein the sleeve is hollow and includes the inner periphery thereof delimiting a through hole, wherein the main body is inserted through the through hole of the sleeve, wherein the first and second circumferential regions are at different diametrical distances from a center of the sleeve, wherein the sleeve is adjustable to a first position including the first circumferential region thereof receiving the tightener such that the tightener is moved to the release position thereof, and to a second position including the second circumferential region thereof receiving the tightener such that the tightener is moved to the tight position thereof.

8. The thread cutter drive extension as claimed in claim 7, wherein the main body and the sleeve are threadly engaged with each other, with the main body including outer threads and the sleeve including inner threads engaging with the outer threads.

9. The thread cutter drive extension as claimed in claim 4, wherein the main body includes a first length section and a second length section, wherein the channel extends in the first length section of the main body, and wherein the cavity extends in the second length section of the main body.

10. The thread cutter drive extension as claimed in claim 9, wherein the channel has a longer length than the cavity, and wherein the first length section of the main body has a longer length than the second length section of the main body.

11. The thread cutter drive extension as claimed in claim 9, wherein the main body has first and second widths in a widthwise direction thereof, with the first width defining a minimum width of an outer periphery at the first length section and the second width defining a minimum width of an outer periphery at the section length section respectively, and with the second width being greater than the first width.

12. The thread cutter drive extension as claimed in claim 7, wherein the tightener is in a form of a sphere.

13. The thread cutter drive extension as claimed in claim 7, wherein the first circumferential region is at a greater diametrical distance from the center of the sleeve than the second circumferential region.

14. The thread cutter drive extension as claimed in claim 8, wherein the main body includes a first length section and a second length section, wherein the channel extends in the first length section of the main body, wherein the cavity extends in the second length section of the main body, and wherein the outer thread extends on the second length section of the main body.

15. The thread cutter drive extension as claimed in claim 7, wherein the sleeve includes the inner periphery thereof defining a grooved circumferential region, wherein the sleeve includes a retainer ring disposed in the grooved circumferential region, wherein the retainer ring is movable with the sleeve, wherein the main body is inserted through a hole of the retainer ring, and wherein the first circumferential region is located between retainer ring and the second circumferential region.

16. The thread cutter drive extension as claimed in claim 8, wherein the inner threads extend on the inner periphery of the sleeve 32a, and wherein the second circumferential region is located between the first circumferential region and the inner threads.

17. A thread cutter drive extension for a power tool comprising:
a main body extending in a lengthwise direction from a first end thereof to a second end thereof, defining a first connecting end at the first end thereof and a second connecting end at the second end thereof respectively, and including a cavity circumferentially delimited in the second connecting end and a hole extending radially through the second connecting end and into the cavity; and
a tightening device disposed on the main body and including a tightener adjustably engaged in the hole, with the tightener movable between a tight position engaging in the cavity and a release position disengaging from the cavity;
wherein the thread cutter drive extension defines a driven end at the first connecting end, with the thread cutter drive extension adapted to be driven by a power tool, and with the power tool connecting to the first connecting end; and
wherein the thread cutter drive extension is adapted to receive a thread die, with the thread die disposed in the cavity.

18. The thread cutter drive extension for a power tool as claimed in claim 17, wherein the first connecting end is in a form of a polygonal structure with a neck having a curved edge.

19. The thread cutter drive extension as claimed in claim 17, wherein the tightener and the hole are threadly engaged with each other, with the tightener including first plurality of threads and the hole includes second plurality of threads engaging with the first plurality of threads.

20. The thread cutter drive extension as claimed in claim 17, wherein the tightening device further includes a sleeve adjustably engaged with the main body and includes an inner periphery thereof defining a first circumferential region and a second circumferential region selectively abutting the tightener, wherein the sleeve is hollow and includes the inner periphery thereof delimiting a through hole, wherein the main body is inserted through the through hole of the sleeve, wherein the first and second circumferential regions are at different diametrical distances from a center of the sleeve, wherein the sleeve is adjustable to a first position including the first circumferential region thereof receiving the tightener such that the tightener is moved to the release position thereof, and to a second position including the second circumferential region thereof receiving the tightener such that the tightener is moved to the tight position thereof.
